(19) United States
(12) Patent Application Publication
(10) Pub. No.: US 2026/0340524 A1
(43) Pub. Date: Oct. 29, 2026

(54) AI-Powered Blended Itinerary Optimization Engine with Real-Time Fallback Resolution

(71) Applicants: Ashton Lightfoot, Atlanta, GA (US); Clinton Brooks, Atlanta, GA (US)

(72) Inventors: Ashton Lightfoot, Atlanta, GA (US); Clinton Brooks, Atlanta, GA (US)

(21) Appl. No.: 19/171,303

(22) Filed: Apr. 6, 2025

(51) Int. Cl. G06Q 10/02; G06F 3/04847; G06N 20/20; G06Q 10/04

(52) U.S. Cl. CPC G06Q 10/021; G06F 3/04847; G06N 20/20; G06Q 10/04

(57) ABSTRACT

A computer-implemented system for generating dynamic travel itineraries based on real-time external data sources including weather forecasts, transit schedules, venue availability, and pricing information. The system processes user-defined travel preferences and constraints to construct an optimized itinerary. When a disruption or constraint renders a scheduled item unfeasible-such as a closure, overbooking, or inclement weather-the system invokes an automated fallback mechanism that selects a substitute item based on a hierarchy of user-defined priorities. The fallback module evaluates real-time data streams to ensure availability and appropriateness of alternatives. The system continuously monitors all itinerary elements, allowing for on-the-fly re-optimization while preserving alignment with user intent. This invention supports seamless, personalized, and resilient travel planning through intelligent, real-time itinerary adjustment and adaptive conflict resolution.

### FIELD OF THE INVENTION

The present invention relates to the field of artificial intelligence systems for travel planning and optimization. More particularly, it pertains to a system and method for generating, adjusting, and re-optimizing travel itineraries in real-time using dynamic data inputs and intelligent fallback resolution mechanisms based on user-defined preferences.

### BACKGROUND OF THE INVENTION

Travelers often rely on digital itinerary planning tools to schedule trips, including visits to attractions, hotel stays, transportation, and meals. Traditional systems offer basic filtering and static recommendations and are unable to adapt dynamically when scheduled activities become infeasible due to factors such as weather changes, overbooking, closures, or transit delays.

Existing systems that provide itinerary generation typically lack robust real-time monitoring and substitution mechanisms.

The invention described herein addresses these limitations by introducing a system that monitors itinerary viability in real-time, intelligently identifies conflicts, and autonomously selects fallback alternatives aligned with user preferences.

### SUMMARY OF THE INVENTION

The present invention provides a novel system and method for real-time itinerary optimization in the domain of travel planning. The invention centers on three core modules: (1) a user preference ingestion engine, (2) a real-time data aggregation layer, and (3) a dynamic fallback logic processor. Together, these enable continuous itinerary optimization and conflict resolution.

### BRIEF DESCRIPTION OF THE DRAWINGS

FIG. 1 illustrates a high-level system architecture of the Al-powered blended itinerary optimization engine. The figure shows data flow between the user input interface, the live data ingestion module, the Al itinerary generation engine, the fallback decision matrix for disruption handling, and the frontend renderer delivering updated itineraries.

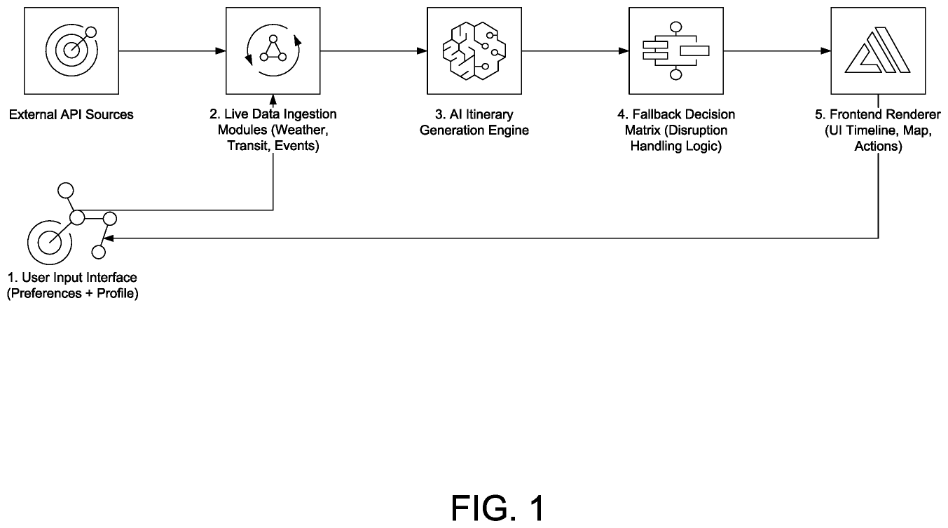

FIG. 2 is a process flow diagram demonstrating the dynamic fallback resolution logic. The flow shows how the system validates scheduled activities, detects conflicts, references user preferences, generates replacement options, and updates the final itinerary following user confirmation or override.

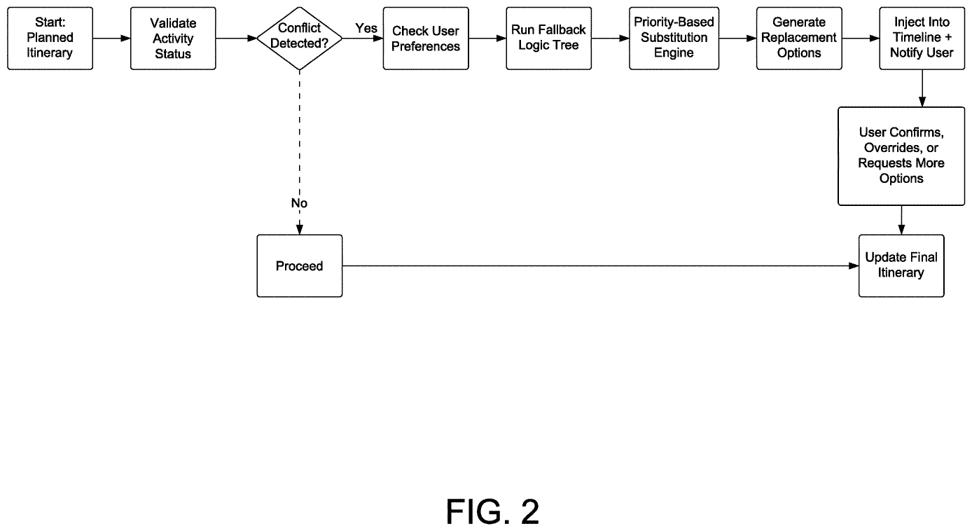

FIG. 3 is a block diagram of the weighted scoring and prioritization system. It depicts how user profile attributes such as budget, culture, food, nature, and speed are converted into normalized vector weights that are processed by a scoring engine to determine itinerary quality and fallback priority.

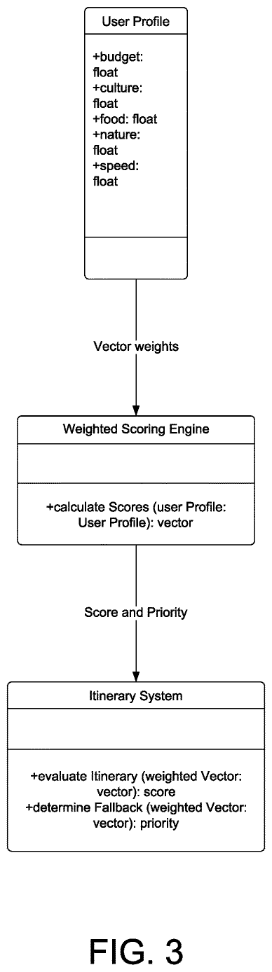

FIG. 4 is a class relationship diagram representing data relationships within the itinerary optimization framework. The figure links entities such as activities, time slots, user feedback, explanation modules, and replacements, illustrating how the system maintains transparency and accountability in automated itinerary adjustments.

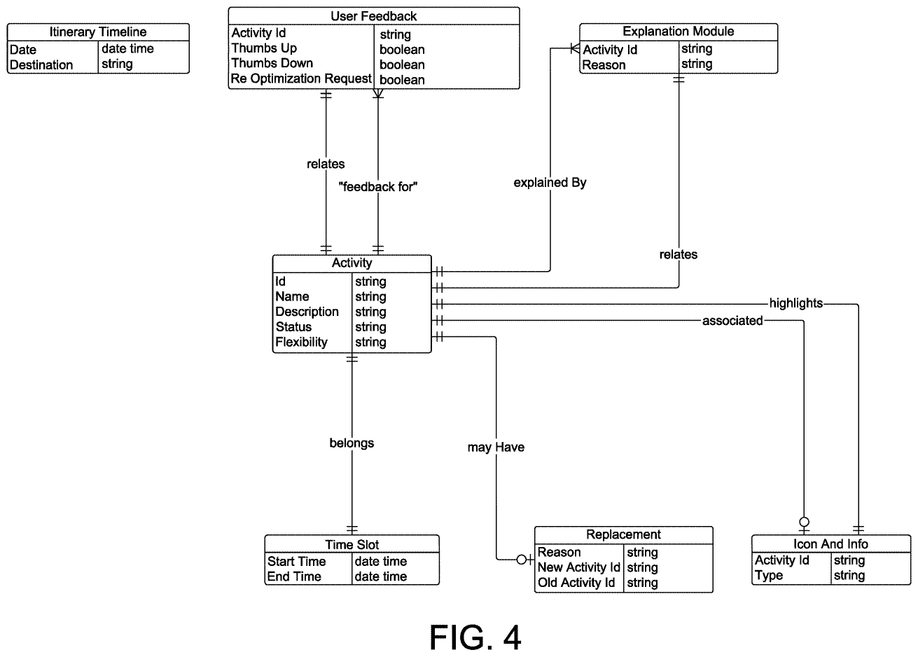

### DETAILED DESCRIPTION OF THE INVENTION

The invention comprises a computer-implemented system, executable through a server-based application or integrated client-side application, capable of constructing and adapting travel itineraries in real-time using live data, user inputs, and fallback logic. Modules include a user preference ingestion engine for collecting parameters like budget, activity type, and time constraints; a data aggregation layer for integrating weather, transit, and venue data; and a fallback logic processor that monitors and replaces invalidated activities.

1. A system for optimizing travel itineraries based on user preferences and real-time data, comprising:
(a) A processor configured to receive user preferences;
(b) An AI engine to process the preferences and generate a personalized itinerary;
(c) A fallback logic system to adjust the itinerary in real-time based on unavailable activities;
(d) A multi-layered machine learning model, comprising decision trees, reinforcement learning, and collaborative filtering techniques to adjust user preferences dynamically based on user behavior and contextual data;
(e) An implicit feedback loop that includes user behavior patterns (e.g., time spent viewing options, activity skips, itinerary re-roll requests), which dynamically adjusts the user preferences based on real-time user interaction and contextual data.

2. The system of claim 1, wherein the fallback logic includes rerouting the itinerary to alternative activities based on the real-time data sources, including weather forecasts, venue availability, and transit schedules.

3. The method of claim 1, wherein user preferences are dynamically updated based on real-time environmental factors, such as weather, time of day, or transit availability.

4. A method for generating personalized travel itineraries, comprising the steps of:
(a) receiving user-defined relative weights for a plurality of travel preferences;
(b) normalizing the user-defined weights into a preference vector;
(c) scoring candidate travel options using the preference vector to generate a ranked set of itinerary elements;
(d) providing a real-time, natural-language explanation for each selected itinerary element that describes how the selection satisfies the user-defined preferences;
(e) dynamically updating the user-defined weights and recalculating the itinerary in real-time based on feedback or additional user input.

5. The method of claim 4, wherein the system employs a combination of decision trees, reinforcement learning, and collaborative filtering to dynamically adjust user preferences based on past behavior, new data, and external factors like weather or venue availability.

6. A system for generating personalized travel itineraries, comprising:
(a) A user input module configured to receive user-defined relative weights for a plurality of travel preferences;
(b) A preference vectorization engine configured to normalize the user-defined weights into a vector representation;
(c) A scoring engine configured to score candidate travel options based on the normalized preference vector and generate a ranked set of itinerary elements;
(d) An explanation generation module configured to provide a natural-language explanation for each selected itinerary element, based on how the element satisfies the user-defined preferences;
(e) A reinforcement learning engine that continually adjusts the itinerary in real-time based on feedback received from the user.

7. The system of claim 6, wherein the user input module further comprises an interactive user interface with sliders or input fields allowing users to adjust the relative weights of their preferences in real-time.

8. The system of claim 6, wherein the explanation generation module provides dynamic explanations using a pre-determined template or machine-learning generated reasoning, allowing for improved clarity and personalization.

9. A non-transitory computer-readable medium having stored thereon computer executable instructions which, when executed by a processor, cause the processor to perform the steps of:
(a) receiving user-defined relative weights for a plurality of travel preferences;
(b) normalizing the user-defined weights into a preference vector;
(c) scoring candidate travel options using the preference vector to generate a ranked set of itinerary elements;
(d) providing a real-time, natural-language explanation for each selected itinerary element that describes how the selection satisfies the user-defined preferences;
(e) dynamically updating the user-defined weights and recalculating the itinerary in real-time based on user feedback or additional input.

10. The system of claim 6, wherein the system integrates external APIs for weather data, transit schedules, venue availability, and ticketing information to continuously monitor itinerary status and update accordingly.

11. The system of claim 1, wherein the fallback logic module is triggered upon detection of a disruption such as:
(a) Weather threshold exceeded (e.g., forecast>70% chance of rain for outdoor events);
(b) Venue marked unavailable via API (status=closed, fully booked);
(c) Delayed or canceled transit affecting scheduled sequence.

12. The system of claim 11, wherein the fallback logic system utilizes a multi-factor decision matrix to select the most appropriate substitute activity, based on user preferences and activity availability, and includes fallback confidence scores to rank substitution options in real-time.
